(19) United States
(12) Patent Application Publication
(10) Pub. No.: US 2018/0247379 A1
(43) Pub. Date: Aug. 30, 2018

(54) EVALUATING POTENTIAL CONNECTIONS BASED ON INSTRUMENTAL VARIABLES

(71) Applicant: Facebook, Inc., Menlo Park (CA)

(72) Inventors: Cheng-huan Sean Chu, Sunnyvale, CA (US); Won Hee Park, Mountain View, CA (US)

(21) Appl. No.: 15/442,597

(22) Filed: Feb. 24, 2017

(51) Int. Cl. G06Q 50/00; G06Q 30/02; G06F 17/30

(52) U.S. Cl. CPC G06Q 50/01; G06F 17/30867; G06Q 30/0269

(57) ABSTRACT

Various embodiments include systems and methods for evaluating potential connections between users of a social networking system. Instrumental variable (IV) models are utilized to estimate a change of user engagement with the social networking system that can be caused by the establishment of a potential connection between users. The estimates can serve as a basis for prioritizing promotional information relating to potential connections.

### BACKGROUND

Users of social networking services may form connections, associations, friendship, or other relationships with other users based on real-life interactions, online interactions, or a wide variety of other bases. For example, users may choose to connect with others who are in the same geographic location, who have a common circle of friends, who have attended the same college or university, etc. However, without doing a specific search for a user, it is a common challenge for users to locate other users with whom they may wish to form a connection. Existing social networking systems provide limited mechanisms for finding such connections. In some instances, for example, social networking systems provide individuals with access to an introduction mechanism. The introduction mechanism may be as simple as showing the profiles of matched individuals through listings or social network visualizations, or through context-aware match alerts and introduction management tools that aim to encourage interpersonal contact. Examples of social matching applications include a “People you may know” feature that uses social-tie data to recommend people to each other.

### BRIEF DESCRIPTION OF THE DRAWINGS

FIG. 1 is a block diagram illustrating a system for evaluating potential connections between users within a social networking system, in accordance with various embodiments.

FIG. 2 is block diagram of an example of the system of FIG. 1.

FIG. 3 is a flow chart of a method for computing an estimated engagement value of a target user to the social networking system, in accordance with various embodiments.

FIG. 4 is a flow chart of a method for evaluating potential connections between users of the social networking system based on estimated engagement change, in accordance with various embodiments.

FIG. 5 is a block diagram illustrating an example of a computing device in the social networking system, in accordance with various embodiments.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

### Configuration Overview

A social networking system may offer users the ability to communicate and interact with other users of the social networking system. Users of the social networking system may form connections, associations, friendship, or other relationships with other users based on real-life interactions, online interactions, or a wide variety of other bases. Mechanisms for suggesting connections may be provided by the social networking system.

One example mechanism for suggesting connections within social networking systems includes determining a number of common “friends” between two users and making an introduction to the two users when the number reaches a threshold. One drawback with such an approach is that the system will likely be skewed toward making more suggestions to users who already have many connections than for users with few connections within the social networking system. This may lead to a suboptimal result for the social networking system because an additional friend for a user with many friends may be less valuable than an additional friend for a user with relatively few friends. For example, an additional friend for a user with relatively few friends maybe more valuable because the addition of a new friend may cause the user to engage more with the social networking system, whereas an additional friend for a user with many friends may not cause much change in the user's social network engagement. Another example mechanism for suggesting connections focuses on simply adding connections among users without regard to the result of the suggested connections.

Various embodiments are disclosed of systems and methods for the social networking system to evaluate potential connections between users based on an estimated change of user engagement with the social networking system that may be caused by establishment of the potential connection. More specifically, one aspect of the current disclosure is directed to determining one or more instrumental variable (IV) models that estimate a causal relationship between a quantifier of connections associated with a user and the user's engagement (e.g., frequency of logins, postings, messages, etc.) with the social networking system. Another aspect of the current disclosure is directed to using the IV model(s) to evaluate various potential connections between different users and selecting those that are likely to cause larger user engagement gains for promoting to the users.

As used herein, a “user” can be an individual or an entity (e.g., a business or third party application). A “connection” can be a connection, link, association, friendship, or other relationship formed between or among users of the social networking system. In use, users join the social networking system and then connect with other users, individuals, and entities with whom they desire to be connected. Additionally, social networking systems provide various communication channels for users to interact with each other within the system. Thus, users of a social networking system may interact with each other by “posting” content items of various types of media through the communication channels. As users increase their interactions with each other within the social networking system, they engage with the social networking system on a more frequent basis.

Ordinary least squares (OLS) regression based methods may be utilized to estimate correlations between variables but may not reflect their causal relationship. IV models enable consistent estimation when OLS based methods produce biased and inconsistent estimates. Given proper instrumental variables, consistent estimates of a causal relationship may be obtained. Generally speaking, in attempting to estimate the causal effect of some variable X (e.g., the number of connections a user made after a first period of time) on another variable Y (e.g., a measure of the user's engagement with the social networking system after a second period of time), an instrumental variable can be a third variable Z that affects Y only through its effect on X.

In accordance with various embodiments, instrumental variable Z can be an m-dimensional vector of dummy variables (z₁, z₂, . . . , zₘ), wherein zᵢ is either 0 or 1 for 1≤i≤m. In this case, Z can represent an assignment of a user to one of m groups. The groups may be defined in accordance with users' exposure to a certain amount or degree of information relating to potential connections (e.g., advertisements or other information suggesting a potential friend that the user may want to establish a connection with). For example, a first group of users may be defined as users who have never been presented with information relating to potential connections, a second group of users may be presented with such information only after a specified period of time, and a third group of users may have always been presented with such information without restrictions. Accordingly, any user of the first group may correspond to an instrumental variable (1, 0, 0); any user of the second group may correspond to an instrumental variable (0, 1, 0); and any user of the third group may correspond to an instrumental variable (0, 0, 1).

An IV model as disclosed herein may include a function Y=F(X) (e.g., a linear regression model) whose parameters or coefficients may be estimated based on historical data (e.g., user demographics, number of connections, level of engagement/activity) associated with a set of existing users of the social networking system, in accordance with the values of each user's instrumental variable. As such, the IV model can be determined and can be used to evaluate other users and their potential connections.

Illustratively, the system may calculate a derivative F′(X) of the function F(X), when evaluated at an input X that corresponds to a target user's current number of connections. The derivative can be considered a quantifier of a causal effect between a change in X (e.g., the target user establishes new connection(s) to other user(s)) and the output Y (e.g., a measure of the target user's engagement with the social networking system at a future time).

Alternatively, the system may calculate a first output Y=F(X) when evaluated at an input X that corresponds to the target user's current number of connections, and the system may further calculate a second output Y′=F(X′) when evaluated at an input X′ that corresponds to the target user's potential number of connections after it establishes new connection(s). The system may calculate a difference between the second output and the first output, as a quantifier of a causal effect that a change in input X may have on output Y.

To evaluate the overall change in user engagement with the social networking system that is caused by a potential connection between user A and user B, the system may calculate individual causal effect quantifiers for user A and user B, respectively, based on a potential establishment of a connection between the two users. A sum, product, or other combination of the two causal effect quantifiers may be used as a weight for describing a value of the potential connection. Given a set of potential connections between different users that can be presented to the users, the system may prioritize those with higher weights (e.g., likely to cause larger gains in overall user engagement with the social networking system) and display promotional information to corresponding users to encourage establishment of the prioritized connections.

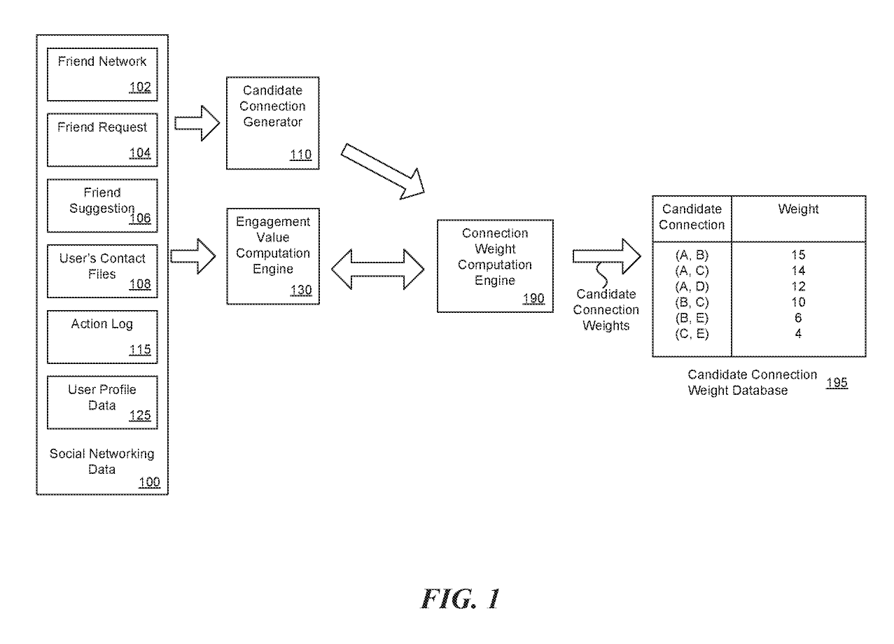

FIG. 1 illustrates a system for evaluating potential connections between users within a social networking system, in accordance with various embodiments. The evaluation can then be used to determine whether or which potential connections should be presented to target users. As illustrated in FIG. 1, the system can include social networking data 100, a candidate connection generator 110, an engagement value computation engine 130, a connection weight computation engine 190, and a database 195 of connection weights assigned to each potential connection between users. A list of connections between users that have not been established in the social networking system is generated by the candidate connection generator 110 by accessing data within the social networking data 100.

In some embodiments, the candidate connection generator 110 generates a list of candidate connections between users by accessing the data stored within the social networking data 100. Illustratively, for each specific user, the candidate connection generator 110 identifies other users within the social networking system who have not yet formed a connection with the specific user but who may be associated in some way to the specific user. For example, the candidate connection generator 110 may populate candidate connections from the specific user to a set of users who may interact with the specific user outside the social networking system but are not connected to the specific user within the social networking system. In other embodiments, the candidate connection generator 110 generates a list of candidate connections between a specific user and friends of the specific user's friends who also share certain similar characteristics with the specific user. A list of similar characteristics may include, but is not limited to: sharing a social network, similar college or high school graduation year, checking into the social network from the same location at about the same time, etc.

The engagement value computation engine 130 generates engagement values for various users within the social networking system by determining and applying IV models to user data. The engagement value is a measure of the involvement or commitment of a user to the social networking system. This can include activities on the social networking system, off the social networking system, or both. For example, any activity that can be tied to social plugins (e.g., “like” or “share” buttons), connecting, involvement, and the like can be used as indicators of or factors for determining the user's engagement. Engagement values may be measured based on activities performed by the user on the social network, such as logins, page views, posts, comments, etc. Engagement values may also take into account activities performed by the user off the social network, such as web browsing and/or commenting, online chatting and/or shopping, social gathering (online and/or offline), etc.

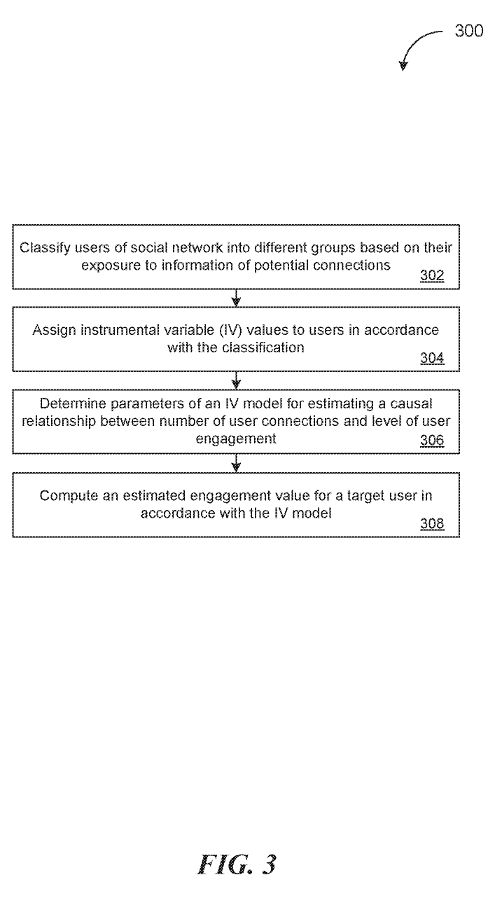

The engagement value computation engine 130 may estimate parameters or coefficients of IV models by accessing various portions of the social networking data 100. Various embodiments for determining and applying IV models to estimate user engagement values are described in greater detail in reference to FIG. 3.

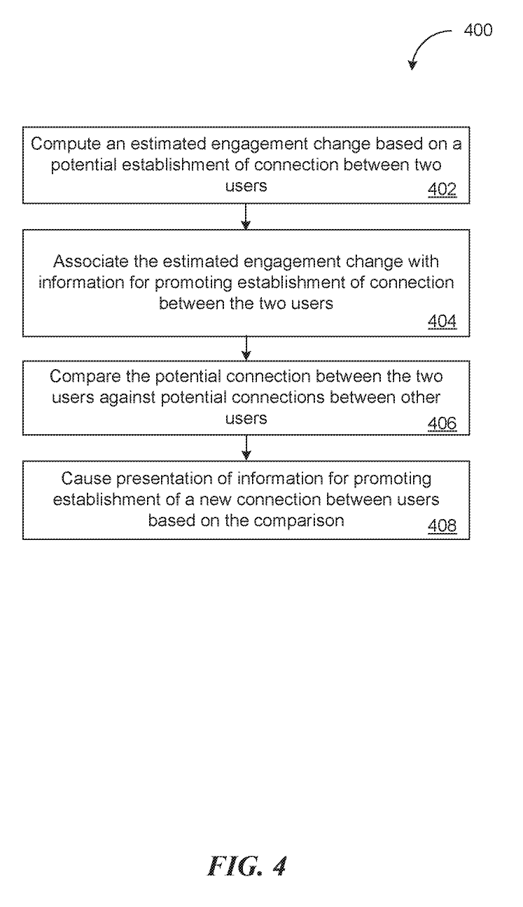

The connection weight computation engine 190 receives the list of candidate connections between users and requests estimated user engagement values from the engagement value computation engine 130. In accordance with some embodiments, the connection weight computation engine 190 computes a weight for each candidate connection based on differences of estimated user engagement values caused by the potential establishment of the candidate connection, as discussed above. In accordance with other embodiments, the connection weight computation engine 190 may request the engagement value computation engine 130 to calculate and return IV function derivatives for users who may form a candidate connection, and compute a weight for the candidate connection based thereon, as discussed above. Each candidate connection may subsequently be ranked in a database 195 based on its respective weight. Various embodiments for computing weights for candidate connections are described in greater detail in reference to FIG. 4.

In some embodiments, the system may only select candidate connections above a certain rank for promotion. An indication of one user of the selected connection can then be displayed to the other user of the selected connection, for example, as somebody that the other user may know, either within or outside the social network. In some embodiments, the system may provide users with suggested connection information only when there is at least one candidate connection with a weight greater than a specific threshold value. In some embodiments, only candidate connections with a weight greater than a specific threshold value are ranked.

In some embodiments, the social networking data 100 includes each user's friend network 102, friend request data 104, friend suggestion data 106, and the user's contact files 108. A friend network 102 can include the names and associated information of all the users who have formed a connection with a specific user. For example, if a second user has accepted a first user's friend request, the two users have formed a connection or a friendship within the social networking system. A friend request can be a request a user sends to a different user to create a connection or link between the two users in their respective social networks and/or social graphs. Each user's name would appear on the other's friend network. The friend request data 104 can include the names and associated information of users who have requested that the user add the users to the first user's friend network 102.

The friend suggestion data 106 can include name and associated information of users who are suggested as friends by other friends of the specific user, mutual friends of the users, or by the social networking system. The user's contact files 108 can include the name and associated information of all the users within the social networking system that the specific user has communicated with, either through email, instant messaging, text messaging, or wall posts within the social network. These are just a few examples of the interactions that a user can engage in within the social networking system. Many others interactions are possible, and described in greater detail below.

In some embodiments, a user's social networking data 100 further comprises historical social networking system usage data as action logs 115 and user profile data 125 of users of the social networking system. In accordance with various embodiments of the present invention, a social network system action log 115 can include usage information associated with each of the users of the social network system. For example, action log 115 associated with a given user could include information such as the number of times a user has utilized the social network within a given time frame, number of connection (e.g., friendship) requests sent/received by a user, number of connection requests of a user accepted by other users, etc. that were captured over various time points. A user profile data 125 comprises information regarding a user's account. For example, user profile data 125 could include information such as number of connections a user had within a given time frame, number of content posts a given user has within the given time frame, etc.

### System Architecture

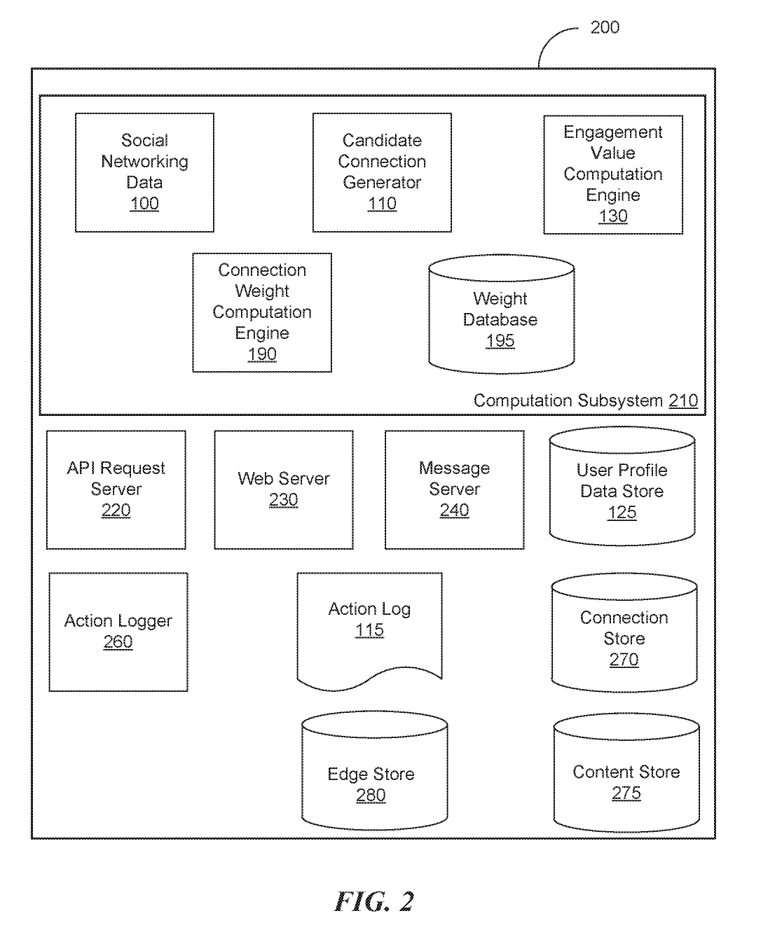

FIG. 2 illustrates a block diagram of an example social networking system 200 having a computation subsystem 210, in accordance with various embodiments. The computation subsystem 210 can be used for evaluating various candidate connections between users and utilizing the evaluation to determine whether or which candidate connections that the system should promote. As illustrated in FIG. 2, the computation subsystem 210, within the social networking system 200, can include users' social networking data 100, a candidate connection generator 110, an engagement value computation engine 130, a connection weight computation engine 190 and a database 195 of weights assigned to each candidate connection. While not shown in FIG. 2, social networking system 200 can also include or communicate with user devices, a financial account provider system, and/or additional components.

In some embodiments, the social networking system 200 can include one or more computing devices storing user profiles associated with users and/or other objects as well as connections between users and other users and/or objects. In use, users join the social networking system 200 and then add connections to other users or objects of the social networking system to which they desire to be connected. Users of the social networking system 200 may be individuals or entities such as businesses, organizations, universities, manufacturers. The social networking system 200 enables its users to interact with each other as well as with other objects maintained by the social networking system 200. In some embodiments, the social networking system 200 allows users to interact with third-party websites and financial account providers.

Based on data stored about users, objects and connections between users and/or objects, the social networking system 200 generates and maintains a “social graph” comprising a plurality of nodes interconnected by a plurality of edges. Each node in the social graph represents an object or user that can act on another node and/or that can be acted on by another node. An edge between two nodes in the social graph represents a particular kind of connection (e.g., friendship) between the two nodes, which may result from an action that was performed by one of the nodes on the other node. For example, when a user identifies an additional user as a friend, an edge in the social graph is generated connecting a node representing the first user and an additional node representing the additional user. The generated edge has a connection type indicating that the users are friends. As various nodes interact with each other, the social networking system 200 modifies edges connecting the various nodes to reflect the interactions.

User devices that interact with social networking system 200 can be any type of computing device capable of receiving user input as well as transmitting and/or receiving data via a network. For example, the user devices can include conventional computer systems, such as a desktop or laptop computer. As another example, the user devices may include a device having computer functionality, such as a personal digital assistant (PDA), mobile telephone, smart-phone or similar device. The user devices are configured to communicate with the social networking system 200, and/or the financial account providers via a network. In some embodiments, a user device may execute an application allowing a user of the user device to interact with the social networking system 200. For example, the user device may execute a browser application to enable interaction between the user device and the social networking system 200 via a network. In another embodiment, a user device can interacts with the social networking system 200 through an application programming interface (API) that runs on the native operating system of the user device, such as IOS® or ANDROID™.

The user devices are configured to communicate via a network, which may comprise any combination of local area and/or wide area networks, using both wired and wireless communication systems. In some embodiments, the network uses standard communications technologies and/or protocols. Thus, the network may include links using technologies such as Ethernet, 802.11, worldwide interoperability for microwave access (WiMAX), 3G, 4G, CDMA, digital subscriber line (DSL), etc. Similarly, the networking protocols used on the network may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network may be represented using technologies and/or formats including hypertext markup language (HTML) or extensible markup language (XML). In addition, all or some of links can be encrypted using conventional encryption technologies such as secure sockets layer (SSL), transport layer security (TLS), and Internet Protocol security (IPsec).

The embodiments of the social networking system 200 shown in FIG. 2 also include an application programming interface (API) request server 220, a web server 230, a message server 240, a user profile data store 125, an action logger 260, an action log 115, a connection store 270. In other embodiments, the social networking system 200 may include additional, fewer, or different modules for various applications. Conventional components such as network interfaces, security mechanisms, load balancers, failover servers, management and network operations consoles, and the like are not shown so as to not obscure the details of the system.

In some embodiments, the system 200 is not a social networking system but communicates with a social networking system to obtain the necessary social network information. As a result, the system 200 may communicate with the social networking system, for example, using APIs provided by the social networking system. In these embodiments, some modules shown in FIG. 2 may run in the system 200, whereas other modules may run in the remote social networking system. For example, the candidate connection generator 110, the engagement value computation engine 130, the connection weight computation engine 190, and others may run in the system 200 while the API request server 220, user profile data store 125, connection store 270, and the action log 115 may exist in a separate social networking system.

The social networking system 200 allows users to communicate or otherwise interact with each other and access content, as described herein. The social networking system 200 stores user profiles in the user profile data store 125. A user profile includes declarative information about the user that was explicitly shared by the user, and may also include profile information inferred by the social networking system 200. In some embodiments, a user profile includes multiple data fields, each data field describing one or more attributes of the corresponding user of the social networking system 200. The user profile information stored in user profile data store 125 describes the users of the social networking system 200, including biographic, demographic, and other types of descriptive information, such as work experience, educational history, gender, sexual preferences, hobbies, location, other preferences, and the like. The user profile may also store information provided by the user. For example, images or videos provided by the user may also be stored within the user profile. In certain embodiments, images of users may be tagged with identification information of the appropriate users whose images are displayed. A user profile in the user profile data store 125 may also maintain references to actions by the corresponding user performed on content items in a content store and stored in an edge store.

A user profile may be associated with one or more financial accounts, allowing the user profile to include data retrieved from or derived from a financial account. A user may specify one or more privacy settings, which are stored in the user profile, that limit information from a financial account that the social networking system 200 is permitted to access. For example, a privacy setting limits the social networking system 200 to accessing the transaction history of the financial account and not the current account balance. As another example, a privacy setting limits the social networking system 200 to a subset of the transaction history of the financial account, allowing the social networking system 200 to access transactions within a specified time range, transactions involving less than a threshold transaction amounts, transactions associated with specified vendor identifiers, transactions associated with vendor identifiers other than specified vendor identifiers or any suitable criteria limiting information from a financial account identified by a user that is accessible by the social networking system 200. In some embodiments, information from the financial account is stored in the user profile data store 125. In other embodiments, it may be stored in the financial account store.

The social networking system 200 further stores data describing one or more connections between different users in the connection store 270. The data describing one or more connections can include a list of connections, a date each connection (e.g., friendship) was made, etc. The connections may be further defined by users, allowing users to specify their relationships with other users. For example, the connections allow users to generate relationships with other users that parallel the users' real-life relationships, such as friends, co-workers, partners, and so forth. In some embodiments, the connection specifies a connection type based on the type of relationship. Examples of the type of relationship include family, friend, colleague, etc. Users may select from predefined types of connections, or define their own connection types as needed.

The web server 230 links the social networking system 200 via a network to one or more client devices; the web server 230 serves web pages, as well as other web-related content, such as Java, Flash, XML, and so forth. The web server 230 may communicate with the message server 240 that provides the functionality of receiving and routing messages between the social networking system 200 and client devices. The messages processed by the message server 240 can be instant messages, queued messages (e.g., email), text and SMS (short message service) messages, or any other suitable messaging technique. In some embodiments, a message sent by a user to another can be viewed by other users of the social networking system 200, for example, by the connections of the user receiving the message. An example of a type of message that can be viewed by other users of the social networking system besides the recipient of the message is a wall post. In some embodiments, a user can send a private message to another user that can only be retrieved by the other user.

When a user takes an action on the social networking system 200, the action can be recorded in an action log 115 subject to any privacy settings and restrictions. In some embodiments, the social networking system 200 maintains the action log 115 as a database of entries. When an action is taken on the social networking system 200, the social networking system 200 can add an entry for that action to the log 115. In accordance with various embodiments, the action logger 260 is capable of receiving communications from the web server 230 about user actions on and/or off the social networking system 200. The action logger 260 populates the action log 115 with information about user actions to track them. This information may be subject to privacy settings associated with the user. Any action that a particular user takes with respect to another user is associated with each user's profile, through information maintained in a database or other data repository, such as the action log 115. Such actions may include, for example, adding a connection to the other user, sending a message to the other user, reading a message from the other user, viewing content associated with the other user, attending an event posted by another user, being tagged in photos with another user, liking an entity, etc. In some embodiments, the action logger 260 receives, subject to one or more privacy settings, transaction information from a financial account associated with a user and identifies user actions from the transaction information. For example, the action logger 260 retrieves vendor identifiers from the financial account's transaction history and identifies an object, such as a page, in the social networking system associated with the vendor identifier. This allows the action logger 260 to identify a user's purchases of products or services that are associated with a page, or another object, in the content store 275. In addition, a number of actions described in connection with other objects are directed at particular users, so these actions are associated with those users as well. These actions are stored in the action log 115.

The action log 115 may be used by the social networking system 200 to track user actions on the social networking system 200, as well as external website that communicate information to the social networking system 200. Users may interact with various objects on the social networking system 200, including commenting on posts, sharing links, and checking-in to physical locations via a mobile device, accessing content items in a sequence or other interactions. Information describing these actions is stored in the action log 115. Additional examples of interactions with objects on the social networking system 204 included in the action log 115 include commenting on a photo album, communications between users, becoming a fan of a musician, adding an event to a calendar, joining a groups, becoming a fan of a brand page, creating an event, authorizing an application, using an application and engaging in a transaction. Additionally, the action log 115 records a user's interactions with advertisements on the social networking system 200 as well as other applications operating on the social networking system 200. In some embodiments, data from the action log 115 is used to infer interests or preferences of the user, augmenting the interests included in the user profile and allowing a more complete understanding of user preferences.

The action log 115 may also store user actions taken on external websites and/or determined from a financial account associated with the user. For example, an e-commerce website that primarily sells sporting equipment at bargain prices may recognize a user of a social networking system 200 through social plug-ins that enable the e-commerce website to identify the user of the social networking system 200. Because users of the social networking system 200 are uniquely identifiable, e-commerce websites, such as this sporting equipment retailer, may use the information about these users as they visit their websites. The action log 115 records data about these users, including webpage viewing histories, advertisements that were engaged, purchases made, and other patterns from shopping and buying. Actions identified by the action logger 115 from the transaction history of a financial account associated with the user allow the action log 115 to record further information about additional types of user actions.

Further, user actions that happened in particular context, such as when the user was shown or was seen accessing particular content on the social networking system 200, are captured along with the particular context and logged. For example, a particular user could be shown/not-shown information regarding candidate users every time the particular user accessed the social networking system 200 for a fixed period of time. Any actions taken by the user during this period of time are logged along with the context information (i.e., candidate users were provided/not provided to the particular user) and are recorded in the action log 115. In addition, a number of actions described below in connection with other objects are directed at particular users, so these actions are associated with those users as well.

The API request server 220 allows external systems to access information from the social networking system 200 by calling APIs. The information provided by the social network may include user profile information or the connection information of users as determined by their individual privacy settings. For example, a system interested in predicting the probability of users forming a connection within a social networking system may send an API request to the social networking system 200 via a network. The API request is received at the social networking system 200 by the API request server 220. The API request server 220 processes the request by determining the appropriate response, which is then communicated back to the requesting system via a network.

The content store 275 stores content items associated with a user profile, such as images, videos or audio files. Content items from the content store 275 may be displayed when a user profile is viewed or when other content associated with the user profile is viewed. For example, displayed content items may show images or video associated with a user profile or show text describing a user's status. Additionally, other content items may facilitate user engagement by encouraging a user to expand his connections to other users, to invite new users to the system or to increase interaction with the social network system by displaying content related to users, objects, activities, or functionalities of the social networking system 200. Examples of social networking content items include suggested connections or suggestions to perform other actions, media provided to, or maintained by, the social networking system 200 (e.g., pictures or videos), status messages or links posted by users to the social networking system, events, groups, pages (e.g., representing an organization or commercial entity), and any other content provided by, or accessible via, the social networking system.

The content store 275 also includes one or more pages associated with entities having user profiles in the user profile data store 125. An entity is a non-individual user of the social networking system 200, such as a business, a vendor, an organization or a university. A page includes content associated with an entity and instructions for presenting the content to a social networking system user. For example, a page identifies content associated with the entity's user profile as well as information describing how to present the content to users viewing the brand page. Vendors may be associated with pages in the content store 275, allowing social networking system users to more easily interact with the vendor via the social networking system 200. A vendor identifier is associated with a vendor's page, allowing the social networking system 200 to identify the vendor and/or to retrieve additional information about the vendor from the user profile data store 125, the action log 115 or from any other suitable source using the vendor identifier. In some embodiments, the content store 275 may also store one or more targeting criteria associated with stored objects and identifying one or more characteristics of a user to which the object is eligible to be presented.

In some embodiments, an edge store 280 stores the information describing connections between users and other objects on the social networking system 200 in edge objects. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 200, such as expressing interest in a page on the social networking system, sharing a link with other users of the social networking system, and commenting on posts made by other users of the social networking system. The edge store 280 stores edge objects that include information about the edge, such as affinity scores for objects, interests, and other users. Affinity scores may be computed by the social networking system 200 over time to approximate a user's affinity for an object, interest, and other users in the social networking system 200 based on the actions performed by the user. Multiple interactions between a user and a specific object may be stored in one edge object in the edge store 280, in some embodiments. In some embodiments, connections between users may be stored in the user profile data store 125, or the user profile data store 125 may access the edge store 280 to determine connections between users.

FIG. 3 is a flow chart of a method 300 for computing an estimated engagement value of a target user to the social networking system 200, in accordance with various embodiments. The method can be implemented, at least in part, by the engagement value computation engine 130. With reference to FIG. 3, in step 302, the engagement value computation engine 130 utilizes the information in the action log 115 and user profile store 125 to classify a subset of users of the social network into two or more groups based on the user's exposure to information of potential connections: a control group and one or more deprivation groups. The users may be divided into the groups at random or selected based on characteristics to ensure an appropriate sampling of the user population (e.g., number of interactions within a certain period, number of friends, etc.).

In accordance with some embodiments, the users of the control group can be provided with information (e.g., via emails, messages, advertisements on social network user interface, etc.) suggesting new connections or may be included in such information provided to other users, without restrictions. In contrast to the control group, there can be various types of deprivation groups in which the users are deprived of exposure to information of potential connections. More specifically, a total deprivation group has users which are never provided information suggesting new connections and are never being included in such information provided to other users. A temporary deprivation group has users which begin to be provided with information suggesting new connections or to be included in such information, only after a specified period of time since some event (e.g., joining the social networking system, logging into the system, etc.). A no show deprivation group has users which are never provided information suggesting new connections, but can be included in such information provided to other users. Finally, a no view deprivation group has users which are provided with information suggesting new connections but are never included in such information that are provided to others users. Ultimately, the information collected from the control group and the deprivation groups can be utilized to determine IV models by the engagement value computation engine 130.

In step 304, the engagement value computation engine 130 assigns instrumental variable values to each of the subset of users in accordance with the classification. Given proper instrumental variables, IV models allow for consistent estimation of causal effects. Generally speaking, in attempting to estimate the causal effect of some variable X (e.g., the number of connections a user established during a first period of time, such the first day or first week of joining the social networking system) on another variable Y (e.g., a measure of the user's engagement with the social networking system during a second period of time, such as during the second week or second month of joining the social network system), an instrumental variable can be a third variable Z which affects Y only through its effect on X.

Instrumental variable Z can be an m-dimensional vector of dummy variables (z₁, z₂, . . . , zₘ), wherein zᵢ∈{0, 1} for 1≤i≤m. In this case, Z can represent an assignment of a user to one of the aforementioned five groups: (1) control group, (2) total deprivation group, (3) temporary deprivation group, (4) no show deprivation group, and (5) no view deprivation group. Any user of group (1) may be assigned a value (1, 0, 0, 0, 0), any user of group (2) may be assigned a value (0, 1, 0, 0, 0), any user of group (3) may be assigned a value (0, 0, 1, 0, 0), any user of group (4) may be assigned a value (0, 0, 0, 1, 0), and any user of group (5) may be assigned a value (0, 0, 0, 0, 1).

In step 306, the engagement value computation engine 130 determines parameters (e.g. coefficients of functions) of one or more IV models for estimating a causal relationship between a user's number of connections and a level of user engagement with the social networking system. Illustratively, an IV model as disclosed herein may include a mathematical function Y=F(X) (e.g., a linear regression model). For a target user, input X can include values corresponding to a number of connections the target user has established during a period of time, various attributes extracted or derived from user profile data of the target user, various actions that the target user has performed during a period of time, etc. The output Y may indicate a level of engagement with the social networking system that the target user will exhibit at a future time or during a future period of time. In some embodiments, the output Y may take a binary form, i.e., the value of Y can be either “active” or “inactive.”

Parameters of the function Y=F(X) may be estimated based on the instrumental variables assigned to each user of the subset of users and observations of the subset of users (which are considered samples). In particular, social networking data 100 associated with each user of the subset of users provides sample observations of input X (e.g., a number of connections individual users established during a first period of time, various attributes extracted or derived from user profile data of the user, various actions that the user performed during the first period of time, etc.) and corresponding sample observations of output Y (e.g., a level of engagement with the social networking system that the user had at a second point in time or during a second period of time.) In one instance, the level of engagement with the social networking system is measured based on the number of times the user has logged into the social networking system in a defined number of days (e.g., last 30 days, last 60 days, etc.). In another instance, a user's level of engagement with the social networking system can be measured by the average number of hours per day the user accessed content available through the social network over a given time period. As discussed above, in some embodiments, sample observations of output Y take a binary form, i.e., either “active” or “inactive.”

In some embodiments, the parameters are estimated using a two-stage method (e.g., two-stage least squares method for linear regression models). In the first stage, the engagement value computation engine 130 estimates parameters that account for a relationship between instrumental variables Z and input X and compute predicted values of X. For example, the engagement value computation engine 130 may perform regression of X on Z based on the instrumental variables and observations associated with each user of the subset. In the second stage, the engagement value computation engine 130 estimates parameters that account for a relationship between the predicted value of X and the output Y. For example, the engagement value computation engine 130 may perform regression of Yon the predicted values of X from the first stage, based on the observations associated with each user of the subset. Once the parameters are estimated, the IV model is determined and can be used to evaluate other users and their potential connections.

In step 308, the engagement value computation engine 130 computes an estimated engagement value for a target user in accordance with the determined IV model. For example, given an input X including a target user's current number of connections (and other input attributes required by the IV model), the engagement value computation engine 130 applies function Y=F(X) (with parameters estimated or otherwise determined in step 306) and returns an output Y that corresponds to an estimated level of engagement of the target user at a future point in time or during a future period of time. As discussed above, the value of Y may be binary. In some embodiments, the engagement value computation engine 130 may compute a derivative F′(X) of the function F(X), when evaluated at the input X including the target user's current number of connections (and other input attributes required by the IV model). The derivative can be considered a quantifier of a causal effect between a change in X (e.g., the target user establishes new connection(s) to other user(s)) and the output Y (e.g., a measure of the target user's engagement with the social networking system at a future time).

FIG. 4 is a flow chart of a method 400 for evaluating potential connections between users of the social networking system based on estimated engagement change, in accordance with various embodiments. The method 400 can be implemented, at least in part, by the connection weight computation engine 190. With reference to FIG. 4, in step 402, the connection weight computation engine 190 computes an estimated engagement change based on a potential establishment of connection between two users (e.g., user A and user B).

In some embodiments, the connection weight computation engine 190 may request the engagement value computation engine 130 to compute and return estimated engagement values based on inputs that correspond to user A and user B, respectively. For user A and user B respectively, the connection weight computation engine 190 may request and retrieve two estimated engagement values: a current value Y and a forecast value Y′. The current value Y can be computed by the engagement value computation engine 130 when it applies an IV model on an input X that includes the user's current number of connections. The forecast value Y′ can be computed by the engagement value computation engine 130 when it applies the IV model on an input X′ that includes the user's potential number of connections after the connection between user A and user B is established. For user A and user B respectively, the connection weight computation engine 190 may then calculate a difference between the forecast value Y′ and the current value Y, as a quantifier of a causal effect between a change in the user's number of connections and the user's level of engagement with the social networking system in the future as defined in accordance with the IV model.

In other embodiments, the connection weight computation engine 190 may request the engagement value computation engine 130 to compute and return derivatives F′(X) of the IV model. For user A and user B respectively, the connection weight computation engine 190 may request and retrieve a derivative, which can be computed by the engagement value computation engine 130 when it evaluates F′(X) at an input X that includes the user's current number of connections. In this case, the derivative can be considered a quantifier of a causal effect between a change in the user's number of connections and the user's level of engagement with the social networking system in the future as defined in accordance with the IV model.

To compute an estimated overall engagement change based on the potential establishment of connection between user A and user B, the connection weight computation engine 190 may calculate a sum, product, or other combination of the causal effect quantifiers of users A and B.

In step 404, the connection weight computation engine 190 associates the estimated overall engagement change with certain information (e.g., messages or advertisements) for promoting the establishment of connection between the two users. Illustratively, the estimated engagement change may be used as a weight for the potential connection, describing a value the potential connection may bring to the social networking system. In step 406, the connection computation engine 190 compares the potential connection between the two users against potential connections between other users. For example, the connection engine 190 may compute estimated engagement changes caused by different potential connections (e.g., between users A and B, A and C, A and D, B and C, B and E, and C and E, as illustrated in FIG. 1), and store and rank the potential connections in the database 195 based on their respective weights.

In step 408, the connection weight computation engine 190 causes presentation of information for promoting the establishment of a new connection between users based on the comparison of step 406. Given a set of potential connections between different users (e.g., the potential connections maintained by database 195) that can be presented to the users, the connection weight computation engine 190 or another component of the social networking system 200 may prioritize those with higher weights (e.g., likely to cause larger gains in overall user engagement with the social networking system) and cause display of promotional information to corresponding users to encourage establishment of the prioritized connections. For example, if the potential connection between user A and user B has priority for presentation, the connection weight computation engine 190 may communicate, directly or indirectly, with web server 230 or message server 240, which may present the information to promote the potential connection to both or either of user A and user B.

While processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. In addition, while processes or blocks are at times shown as being performed in series, these processes or blocks may instead be performed in parallel, or may be performed at different times. When a process or step is “based on” a value or a computation, the process or step should be interpreted as based at least on that value or that computation.

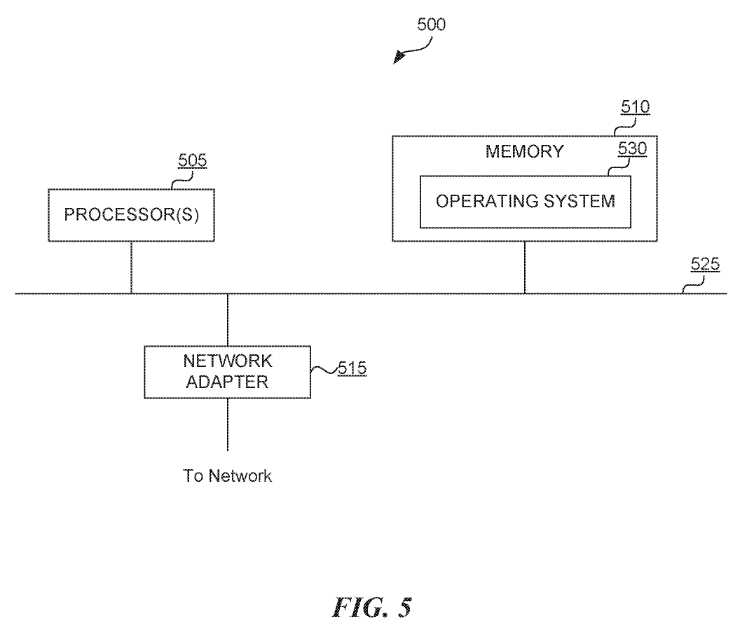

FIG. 5 is a block diagram illustrating an example of the architecture for a computer system or device 500 that can be utilized to implement various functionalities in a social networking system (e.g., the social networking system 200 from FIG. 2). In FIG. 5, the computer system 500 includes one or more processors 505 and memory 510 connected via an interconnect 525. The interconnect 525 may represent any one or more separate physical buses, point to point connections, or both connected by appropriate bridges, adapters, or controllers. The interconnect 525, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 674 bus, sometimes referred to as “Firewire”.

The processor(s) 505 may include central processing units (CPUs) to control the overall operation of, for example, the host computer. In certain embodiments, the processor(s) 505 accomplish this by executing software or firmware stored in memory 510. The processor(s) 505 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 510 is or includes the main memory of the computer system. The memory 510 represents any form of random access memory (RAM), read-only memory (ROM), flash memory (as discussed above), or the like, or a combination of such devices. In use, the memory 510 may contain, among other things, a set of machine instructions which, when executed by processor 505, causes the processor 505 to perform operations to implement embodiments of the present invention.

Also connected to the processor(s) 505 through the interconnect 525 is a network adapter 515. The network adapter 515 provides the computer system 500 with the ability to communicate with remote devices, such as the storage clients, and/or other storage servers, and may be, for example, an Ethernet adapter or Fiber Channel adapter.

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

Some embodiments of the disclosure have other aspects, elements, features, and steps in addition to or in place of what is described above. These potential additions and replacements are described throughout the rest of the specification. Reference in this specification to “various embodiments,” “certain embodiments,” or “some embodiments” means that a particular feature, structure, or characteristic described in connection with the embodiment is included in at least one embodiment of the disclosure. These embodiments, even alternative embodiments (e.g., referenced as “other embodiments”) are not mutually exclusive of other embodiments. Moreover, various features are described which may be exhibited by some embodiments and not by others. Similarly, various requirements are described which may be requirements for some embodiments but not other embodiments.

What is claimed is:

1. A computer-implemented method, comprising:
determining a first predicted change in user engagement with a social network based at least in part on a potential establishment of friendship between the target user and a first user in accordance with an instrumental variable (IV) model;
determining a second predicted change in user engagement with the social network based at least in part on a potential establishment of friendship between the target user and a second user in accordance with the IV model;
comparing the first predicted change with the second predicted change; and
in response to determining that the second predicted change is larger than the first predicted change, causing presentation to at least one of the target user or the second user of information regarding the potential establishment of friendship between the target user and the second user.

2. The method of claim 1, wherein determining the first predicted change comprises calculating a sum of a predicted engagement difference associated with the target user and a predicted engagement difference associated with the first user.

3. The method of claim 2, further comprising calculating the predicted engagement difference associated with the target user based at least in part on an output of the IV model when evaluated in part on a numerical quantifier of friends current associated with the target user.

4. The method of claim 3, wherein calculating the predicted engagement difference associated with the target user is further based on an output of the IV model when evaluated in part on a numerical quantifier of friends potentially associated with the target user, wherein the friends potentially associated with the target user include the first user.

5. The method of claim 2, further comprising calculating the predicted engagement difference associated with the first user based at least in part on an output of the IV model when evaluated in part on a numerical quantifier of friends currently associated with the first user.

6. The method of claim 5, wherein calculating the predicted engagement difference associated with the first user is further based on an output of the IV model when evaluated in part on a numerical quantifier of friends potentially associated with the first user, wherein the friends potentially associated with the first user include the target user.

7. The method of claim 1, wherein one or more instrumental variables of the IV model indicate a classification of users in the social network in accordance with individual user's exposure to information regarding potential establishment of friendship.

8. The method of claim 7, wherein the one or more instrumental variables of the IV model comprise at least one dummy variable whose value is either 1 or 0.

9. A non-transitory computer-readable medium storing computer-executable instructions that, when executed by one or more processors, cause the one or more processors to perform operations comprising:
determining a first predicted change in user engagement with a social network based at least in part on a potential establishment of friendship between the target user and a first user in accordance with an instrumental variable (IV) model;
determining a second predicted change in user engagement with the social network based at least in part on a potential establishment of friendship between the target user and a second user in accordance with the IV model;
comparing the first predicted change with the second predicted change; and
in response to determining that the second predicted change is larger than the first predicted change, causing presentation to at least one of the target user or the second user of information regarding the potential establishment of friendship between the target user and the second user.

10. The non-transitory computer-readable medium of claim 9, wherein the IV model is generated based at least in part on historical user friendship data and historical user engagement data.

11. The non-transitory computer-readable medium of claim 10, wherein the historical user friendship data comprises a respective number of friends associated with individual users of a plurality of users during a first period of time.

12. The non-transitory computer-readable medium of claim 11, wherein the historical user engagement data comprises, for individual users of a plurality of users, at least one of:
a number of times the user logs into the social network during a second period of time;
a duration of the day during which the user logs into the social network during the second period of time;
a type of computing device that the user primarily uses for logging into the social network during the second period of time; or
an amount of time spent by the user accessing content within the social network during the second period of time.

13. The non-transitory computer-readable medium of claim 9, wherein one or more instrumental variables of the IV model indicate a classification of users in the social network in accordance with individual user's exposure to information regarding potential establishment of friendship.

14. The non-transitory computer-readable medium of claim 13, wherein the classification of users comprises a first class of users who have not been presented information regarding potential establishment of friendship, a second class of users who have been presented information regarding potential establishment of friendship during a specified period of time, and a third class of users who have constantly been presented with information regarding potential establishment of friendship.

15. The non-transitory computer-readable medium of claim 9, wherein at least one of the first or second users is selected based at least in part on a potential strength of connection to the target user, and the potential strength computed as a function of one or more commonalities between the target user and the at least one of the first or second users.

16. A system comprising:
one or more processors;
a memory configured to store a set of instructions, which when executed by the one or more processors cause the system to perform a method, the method comprising:
determining a first predicted change in user engagement with a social network based at least in part on a potential establishment of friendship between the target user and a first user in accordance with an instrumental variable (IV) model;
determining a second predicted change in user engagement with the social network based at least in part on a potential establishment of friendship between the target user and a second user in accordance with the IV model;
prioritizing promotional information regarding the potential establishment of friendship between the target user and the first user and between the target user and the second user, based at least in part on the first and second predicted changes; and
causing presentation of the promotional information in accordance with the prioritizing.

17. The system of claim 16, wherein the IV model comprises a function that outputs a measure of engagement with the social network for a specified user.

18. The system of claim 17, wherein the IV model is configured to predict a causal effect between one or more inputs of the function and the measure of engagement with the social network for the specified user.

19. The system of claim 18, wherein the one or more inputs of the function include a numerical quantifier of a set of friends associated with the specified user.

20. The system of claim 18, wherein the one or more inputs of the function further include demographic information of the specified user.

21. The system of claim 17, wherein one or more coefficients of the function are determined based, at least in part, on one or more instrumental variables indicating a classification of users.
